(19) United States
(12) Patent Application Publication
(10) Pub. No.: US 2002/0088660 A1
(43) Pub. Date: Jul. 11, 2002

(54) SCOOTER WITH POWER RELEASING DEVICE

(76) Inventor: Wai Yee Wong, Hong Kong (CN)

Correspondence Address: Raymond Yat Chan, 1050 Oakdale Lane, Arcadia, CA, 91006, US

(21) Appl. No.: 09/755,888

(22) Filed: Jan. 5, 2001

(51) Int. Cl. B62K 11/00

(52) U.S. Cl. 180/220

(57) ABSTRACT

A scooter includes a frame, a rear wheel assembly including a rear wheel rotatably supported at a rear portion of the frame, a power generator for driving an output axle to rotate, a friction rotor connected to the output axle which drives the friction rotor to rotate, wherein the friction rotor is supported to extend to bias against a driven portion of the rear wheel assembly so as to drive the rear wheel to rotate, and a power releasing device arranged to drive the friction rotor from a driving position to an idle position, wherein in the driving position, the friction rotor is frictionally bias against the driven portion of the rear wheel assembly to drive the rear wheel to rotate, and in the idle position, the friction rotor is moved away from the driven portion of the rear wheel assembly such that the rear wheel is in a free rotating manner.

### BACKGROUND OF THE PRESENT INVENTION

1. Field of Invention

The present invention relates to a scooter, and more particularly to a scooter equipped with a power releasing device, wherein the scooter is powered by frictional force so as to eliminate the co-operation of a transmission. Furthermore, the power releasing device employed in the scooter enables the scooter be selectively impelled by electrical power or by foot manually.

2. Description of Related Arts

Nowadays, scooters are well known and have been considered as a form of transportation, recreation, and exercise. A conventional scooter comprises a step board for supporting a rider in a standing position, a steering frame having a front wheel operatively attached to a front portion of the step board, and a rear wheel rotatably attached to a rear portion of the step board. In which, one foot of the rider is supported on the step board while the conventional scooter is propelled by another foot of the rider. It is no doubt that the conventional scooter is lightweight, portable, and safe. However, the rider may still have a chance to carry the scooter especially when the rider is tired while operating for a long period of time. So, an alternative is sought for. An improved scooter is equipped with an electric motor or an engine so that such scooter is propelled by means of mechanical power.

However, the motorized scooter still has many drawbacks. When the scooter is equipped with a motor, the structure of the scooter must be altered in order to fit the motor. Such complex structure of the scooter will highly increase the manufacturing cost and the maintenance cost of the scooter. Also, the motor will increase the overall weight of the scooter so as to loss most of the ordinary features such as lightweight and portable of the scooter. Since the motorized scooter is powered by the motor all the time, the scooter has loss a meaning of exercise.

In addition, the major drawback of the motorized scooter is that no matter what the rear wheel of the scooter is driven by means of driving belt or directly by a rotor shaft extended from the motor, when the scooter uses up its power, the rear wheel of the scooter is locked up by the motor. So, the rider may merely carry the heavy scooter by hand instead of rolling the scooter on the street.

### SUMMARY OF THE PRESENT INVENTION

A main object of the present invention is to provide a scooter which is propelled by a frictional force generated by a power generator, wherein the powered scooter is adapted for selectively propelling by the frictional force from the power generator or by foot manually. The user may switch the scooter to powered operate or to manual operate anytime and anywhere easily. In other words, even though the power generator is run out of power, the powered scooter can be operated by manually.

Another object of the present invention is to provide a powered scooter which does not require to alter the original simple structure so as to reduce the manufacturing cost of the scooter incorporating with the motor.

Another object of the present invention is to provide a powered scooter, which is adapted to selectively adjust a transmitting power from the power generator, i.e. the transmission of the scooter, by means of the frictional force.

Accordingly, in order to accomplish the above objects, the present invention provides a scooter, which comprises:

a frame;

a front wheel rotatably supported at a front portion of the frame;

a rear wheel assembly comprising at least a rear wheel rotatably supported at a rear portion of the frame;

a power generator pivotally mounted on the frame for driving an output axle to rotate;

a power source connecting to the power generator;

a friction rotor connected to the output axle which drives the friction rotor to rotate, wherein the friction rotor is supported to extend to bias against at least a driven portion of the rear wheel assembly so as to drive the rear wheel to rotate; and

a power releasing device for operating and maintaining the friction rotor selectively between a driving position and an idle position, wherein in the driving position, the friction rotor is frictionally bias against the driven portion of the rear wheel assembly to drive the rear wheel to rotate, and in the idle position, the friction rotor is moved away from the driven portion of the rear wheel assembly such that the rear wheel is in a free rotating manner.

### BRIEF DESCRIPTION OF THE DRAWINGS

FIG. 1 is a rear perspective view of a scooter according to a preferred embodiment of the present invention.

FIG. 2 is a partially perspective view of the scooter according to the above preferred embodiment of the present invention.

FIG. 3 is a rear view of the scooter according to the above preferred embodiment of the present invention.

FIG. 4 is a partially exploded perspective view of the scooter according to the above preferred embodiment.

FIG. 5 illustrates a power generator of the scooter in a driving position according to the above preferred embodiment of the present invention.

FIG. 6 illustrates the power generator of the scooter in an idle position according to the above preferred embodiment of the present invention.

FIG. 7 illustrates a first alternative mode of a power releasing device of the scooter according to the above preferred embodiment of the present invention.

FIG. 8 illustrates a second alternative mode of the power releasing device of the scooter according to the above preferred embodiment of the present invention.

### DETAILED DESCRIPTION OF THE PREFERRED EMBODIMENT

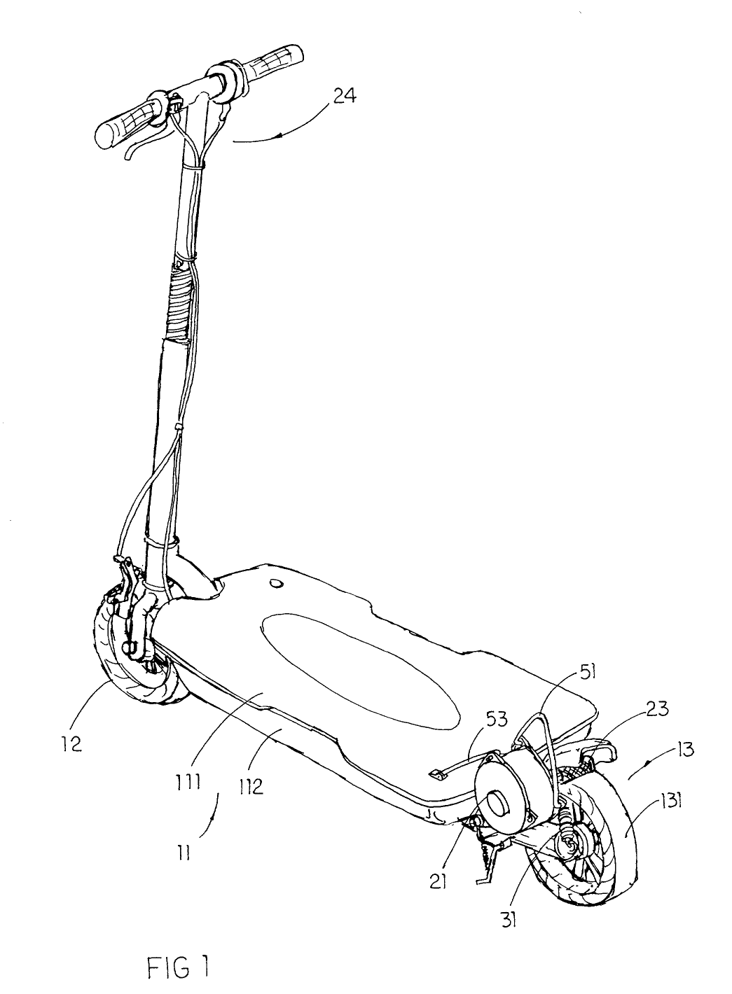

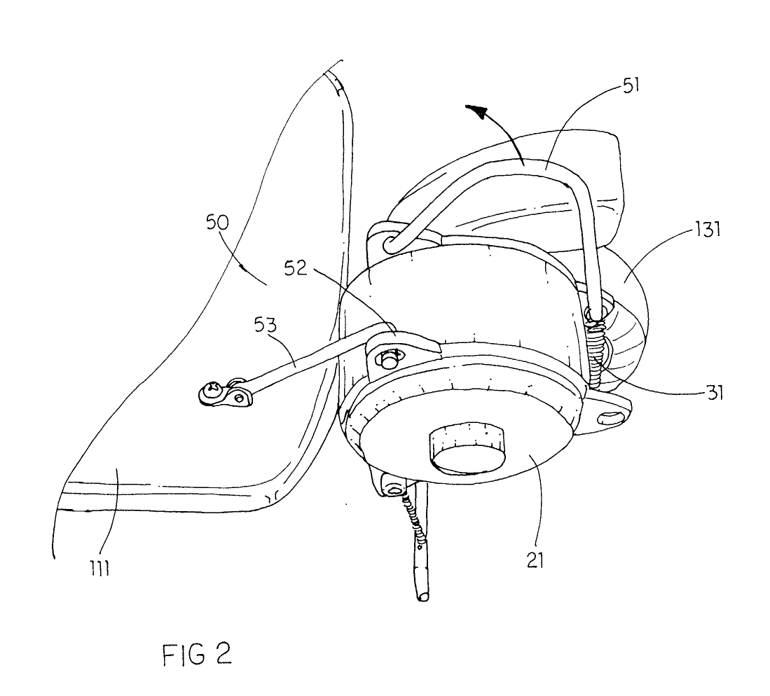

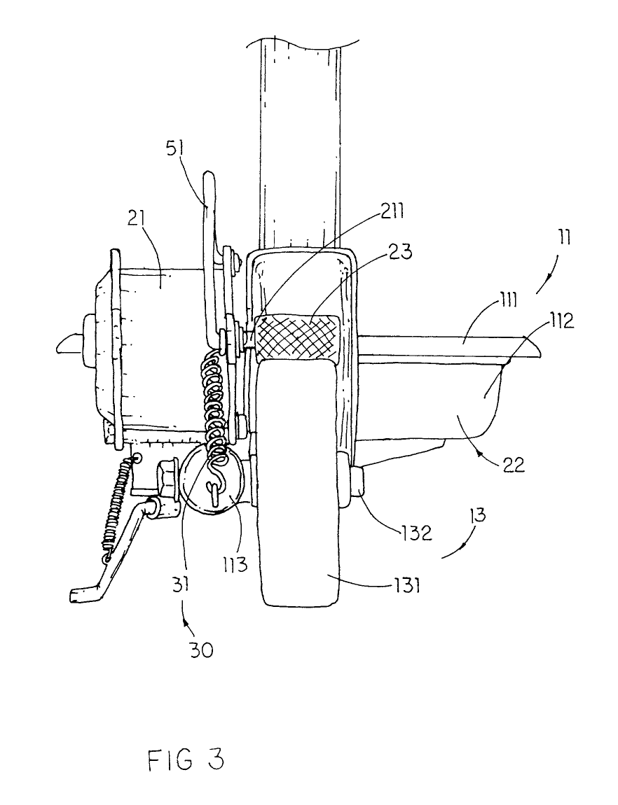

Referring to FIGS. 1 through 3 of the drawings, a scooter according to a preferred embodiment of the present invention is illustrated, wherein the scooter, such as a standard scooter, comprises a frame 11, a front wheel 12 rotatably supported at a front portion of the frame 11, and a rear wheel assembly 13 comprising at least a rear wheel 131 rotatably supported at rear portion of the frame 11.

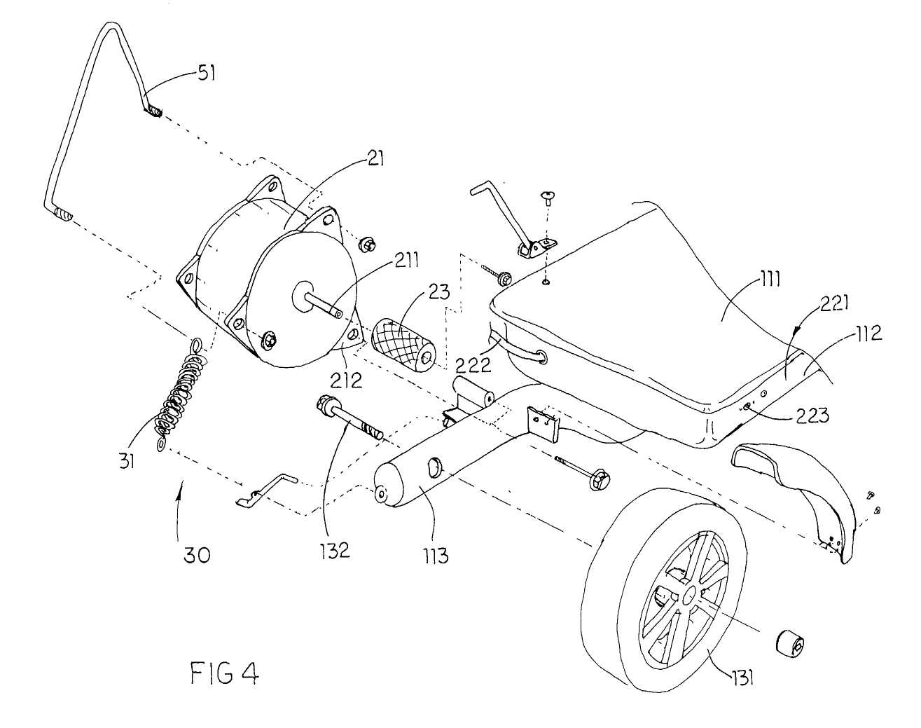

As shown in FIG. 4, the scooter further comprises a powered assembly comprising a power generator 21, which is pivotally mounted on the frame 11, for driving an output axle 211 to rotate, a power source 22 connecting to the power generator 21, a friction rotor 23 connected to the output axle 211 which drives the friction rotor 23 to rotate, wherein the friction rotor 23 is supported to extend to bias against at least a driven portion of the rear wheel assembly 13 so as to drive the rear wheel 131 to rotate, and means for controllably coupling 24 rotational energy from the power generator 21 to the rear wheel assembly 13.

The scooter further comprises a power releasing device 50 arranged to operate and maintain the friction rotor 23 between a driving position and an idle position. In the driving position, the friction rotor 23 is frictionally biased against the driven portion of the rear wheel assembly 13 to drive the rear wheel 131 to rotate. In the idle position, the friction rotor 23 is moved away from the driven portion of the rear wheel assembly 13 such that the rear wheel 131 is in a free rotating manner.

According to the preferred embodiment, the frame 11 comprises a step board 111 for supporting a rider thereon, a housing 112 provided underneath the step board 111 for receiving and protecting the power source 22, and a supporting bar 113 supportively mounted underneath the housing 112 wherein the rear wheel 131 is rotatably supported at a rear portion of the supporting bar 113 by means of a driving axle 132.

The power generator 21 is detachably mounted at a rear portion of the supporting bar 113 by means of, for example, a bolt and nut connection and other similar detachable connection means, wherein the power generator 21 is aligned in parallel with the rear wheel 131 so as to extend the output axle 211 of the power generator 21 towards the rear wheel 131. The power generator 21 can be an electric or a fuel engine.

The friction rotor 23 is preferably made of durable rough material that can provide friction between the friction rotor 23 and the driving portion of the rear wheel assembly 13, so as to drive the rear wheel 131 to rotate. As shown in FIG. 5, the friction rotor 23 is suspendedly supported by the output axle 211 and arranged to frictionally engage with a periphery surface (driven portion) of the rear wheel 131 in such a manner that the power generator 21 is arranged to drive the friction rotor 23 to rotate through the output axle 211 so as to frictionally drive the rear wheel 131 to rotate.

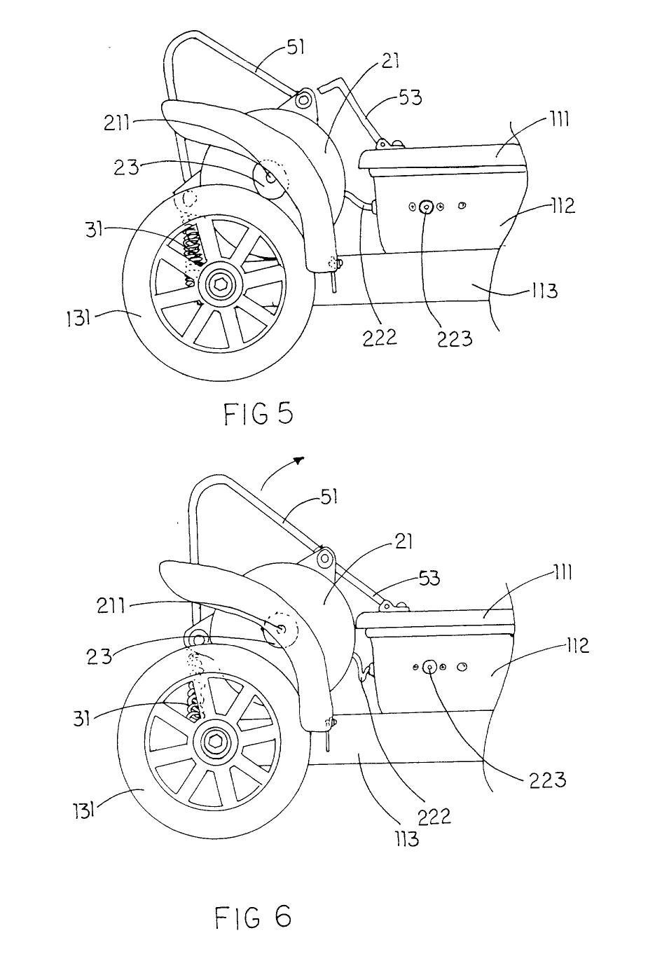

The power generator 21 is pivotally mounted on the supporting bar 113 at an inner portion thereof wherein the power generator 21 is adapted for pivotally moving on the frame 11 from the normal driving position as shown in FIG. 5, to the idle position as shown in FIG. 6. In which, in the driving position, the friction rotor 23 is frictionally biased against the periphery surface of the rear wheel 131 of the rear wheel assembly 13 so as to drive the rear wheel 131 to rotate. In the idle position, the friction rotor 23 is moved away from the periphery surface of the rear wheel 131 of the rear wheel assembly 13 such that the rear wheel 131 is in a free rotating manner.

The power releasing device 50 comprises a handle bar 51 having two ends attached to the power generator 21 wherein the power generator 21 is arranged to pivotally rotate by pulling the handle bar upwardly in such a manner that the friction rotor 23 is driven to move away from the periphery surface of the rear wheel 131 so as to disengage the friction rotor 23 with the rear wheel 131.

The power releasing device 50 further comprises a first locking member 52 provided on the power generator 21 and a corresponding second member 53 provided on the frame 11 wherein the first locking member 52 is adapted for detachably connecting with the second locking member 53 so as to securely holding the power generator 21 in the idle position.

According to the first preferred embodiment, the first locking member 52 is an engaging ring and the second locking member 53 is an elongated hook adapted for detachably hooking on the engaging ring to lock up the power generator 21 in the idle position so as to disengage the friction rotor 23 with the periphery surface of the rear wheel 131.

The scooter further comprises a reinforcing engagement device 30 for applying an urging pressure against the power generator 21 so as to normally retain the power generator 21 in the driving position. The reinforcing engagement device 30, according to the preferred embodiment, comprises a resilient element 31 which is a compression spring detachably attached between the power generator 21 and the frame 11.

In order to ensure a good frictional contact between the friction rotor 23 and the rear wheel 131, the power generator 21 is preferred to mount to the supporting bar 113 pivotally, wherein a supporting member 212, which is protruded at a front bottom end of the power generator 21, is pivotally connected to the supporting bar 113, as shown in FIG. 4. Moreover, the powered scooter further comprises a reinforcing engagement device 30 for applying an urging pressure against the power generator 21 so as to normally retain the power generator 21 in the driving position. The reinforcing engagement device 30, according to the preferred embodiment, comprises a resilient element 31 which is a compression spring detachably attached between the power generator 21 and the supporting bar 113 of the frame 11.

The resilient element 31 has two ends connecting with a rear end of the supporting bar 113 and an outer portion of the power generator 21 respectively. Accordingly, the resilient element 31 will normally urge and retain the power generator 21 in a lower position that the friction rotor 23 is frictionally biased against the periphery surface of the rear wheel 131 to drive the rear wheel 131 to rotate, so as to ensure the frictional power transmission between the friction rotor 23 and the rear wheel 131.

It is worth to mention that the inner portion of the power generator 21 is pivotally mounted on the supporting bar 113 of the frame 11 and the outer portion of the power generator 21 is urged by the resilient element 31. By the pivotal movement, a distance between the outer portion of the power generator 21 and the inner portion thereof will increase a pivotal pulling force of the resilient element 31 such that the resilient element 31 can be pivotally pull down the power generator 21 in the lower position so as to enhance the friction rotor 23 engaged with the rear wheel 131.

The power source 22 comprises at least a rechargeable battery 221 received and protected in the housing 112 of the frame 11 and an electrical wire 222 extended from the rechargeable battery 221 to the power generator 21 through the housing 112. A transmitting power input 223 is adapted to electrically extend from the rechargeable battery 221 such that the rechargeable battery 221 is adapted for selectively recharging by an AC current charger or a DC current car charger through the transmitting power input 223.

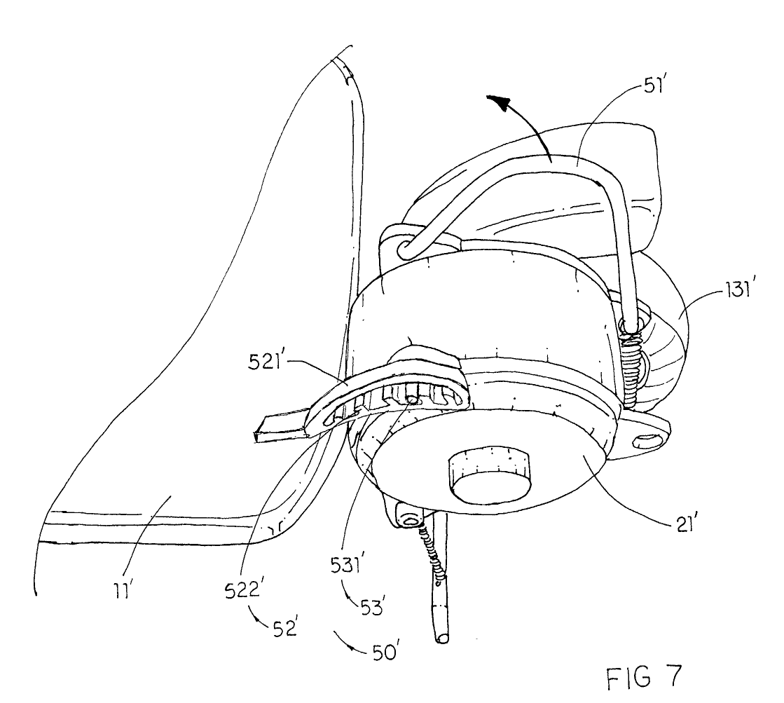

FIG. 7 illustrates an alternative mode of the power releasing device 50′ according to the preferred embodiment of the present invention, wherein the power releasing device 50′ comprises a handle bar 51′ having two ends attached to the power generator 21′ to pivotally pull the power generator 21′ from the driving position to the idle position, a first locking member 52′ provided on the power generator 21′ and a corresponding second member 53′ provided on the frame 11′ wherein the first locking member 52′ is adapted for detachably engaging with the second locking member 53′ so as to securely holding the power generator 21′ in the idle position.

Accordingly, the first locking member 52′ is a curved engaging track 521′ having a predetermined curvature wherein at least an engaging tooth 522′ is formed on the engaging track 521′ and the second locking member 53′ is an elongated protrusion 531′ outwardly protruded from an adequate position of the power generator 21′ and adapted for slidably engaging with the engaging tooth 522′ along the engaging track 521′ to lock up the power generator 21′ in the idle position so as to disengage the friction rotor 23′ with the periphery surface of the rear wheel 131′

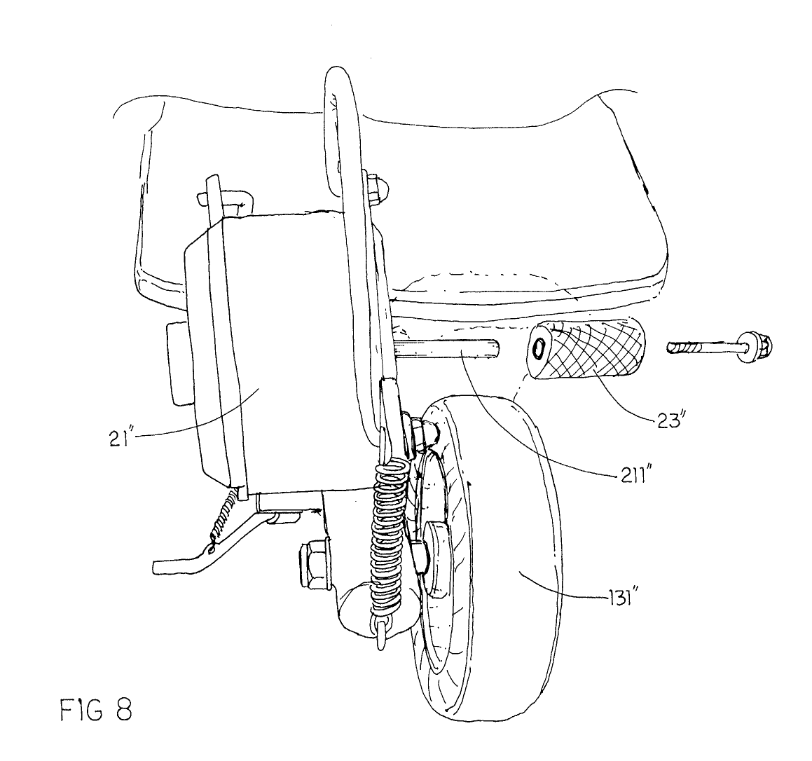

Alternatively, the friction rotor 23″ is detachably attached to the output axle 211″, as shown in FIG. 8, wherein a connecting bolt is coaxially connected to the output axle 211″ through the friction rotor 23″ in such a manner that the friction rotor 23″ is adapted to selectively attach to and detach from the output axle 211″ of the power generator 21″ in the driving position and in the idle position respectively.

So, a rider is able to selectively choose the scooter to be powered by the power generator or by rider's foot. In the driving position, the scooter is propelled by the power generator and in the idle position, the power scooter is operated by the rider's foot as the conventional foot operated scooter.

What is claimed is:

1. A scooter, comprising:
a frame;
a front wheel rotatably supported at a front portion of said frame;
a rear wheel assembly comprising at least a rear wheel rotatably supported at a rear portion of said frame;
a power generator pivotally mounted on said frame for driving an output axle to rotate;
a power source connecting to said power generator;
a friction rotor connected to said output axle which drives said friction rotor to rotate, wherein said friction rotor is supported to extend to bias against at least a driven portion of said rear wheel assembly so as to drive said rear wheel to rotate; and
a power releasing means for operating and maintaining the friction rotor selectively between a driving position and an idle position, wherein in the driving position, the friction rotor is frictionally bias against the driven portion of the rear wheel assembly to drive the rear wheel to rotate, and in the idle position, the friction rotor is moved from the driven portion of the rear wheel assembly so as to maintain the rear wheel in a free rotating manner.

2. A scooter, as recited in claim 1, wherein said power releasing device comprises a first locking member provided on said power generator, and a second locking member provided on said frame for detachably connecting with said first locking member so as to maintain said power generator in said idle position.

3. A scooter, as recited in claim 2, wherein said first locking member is an engaging ring and said second locking member is an elongated hook adapted for detachably hooking on said engaging ring to lock up said power generator in said idle position so as to move said friction rotor away from said driven portion of said rear wheel assembly.

4. A scooter, as recited in claim 2, wherein said first locking member comprises a curved engaging track having a predetermined curvature while at least an engaging tooth is formed on said engaging track, and said second locking member comprises an elongated protrusion outwardly protruded from an adequate position of said power generator for slidably engaging with said engaging tooth along said engaging track to lock up said power generator in said idle position.

5. A scooter, as recited in claim 1, wherein said frame comprises a step board and a supporting bar supportively mounted underneath said step board wherein said power generator at an inner portion thereof is pivotally mounted on a rear end portion of said supporting bar to pivotally move from said driving position to said idle position, wherein said scooter further comprises a reinforcing engagement device for applying an urging pressure against said power generator so as to normally retain said power generator in said driving position.

6. A scooter, as recited in claim 2, wherein said frame comprises a step board and a supporting bar supportively mounted underneath said step board wherein said power generator at an inner portion thereof is pivotally mounted on a rear end portion of said supporting bar to pivotally move from said driving position to said idle position, wherein said scooter further comprises a reinforcing engagement device for applying an urging pressure against said power generator so as to normally retain said power generator in said driving position.

7. A scooter, as recited in claim 3, wherein said frame comprises a step board and a supporting bar supportively mounted underneath said step board wherein said power generator at an inner portion thereof is pivotally mounted on a rear end portion of said supporting bar to pivotally move from said driving position to said idle position, wherein said scooter further comprises a reinforcing engagement device for applying an urging pressure against said power generator so as to normally retain said power generator in said driving position.

8. A scooter, as recited in claim 4, wherein said frame comprises a step board and a supporting bar supportively mounted underneath said step board wherein said power generator at an inner portion thereof is pivotally mounted on a rear end portion of said supporting bar to pivotally move from said driving position to said idle position, wherein said scooter further comprises a reinforcing engagement device for applying an urging pressure against said power generator so as to normally retain said power generator in said driving position.

9. A scooter, as recited in claim 5, wherein said reinforcing engagement device comprises a resilient element having two ends connecting with said rear end portion of said supporting bar of said frame and an outer portion of said power generator respectively, wherein said resilient element normally urges and retains said power generator in a lower position that said friction rotor is frictionally biased against said driven portion of said rear wheel assembly to drive said rear wheel to rotate, so as to ensure a frictional power transmission between said friction rotor and said driven portion of said rear wheel assembly.

10. A scooter, as recited in claim 6, wherein said reinforcing engagement device comprises a resilient element having two ends connecting with said rear end portion of said supporting bar of said frame and an outer portion of said power generator respectively, wherein said resilient element normally urges and retains said power generator in a lower position that said friction rotor is frictionally biased against said driven portion of said rear wheel assembly to drive said rear wheel to rotate, so as to ensure a frictional power transmission between said friction rotor and said driven portion of said rear wheel assembly.

11. A scooter, as recited in claim 7, wherein said reinforcing engagement device comprises a resilient element having two ends connecting with said rear end portion of said supporting bar of said frame and an outer portion of said power generator respectively, wherein said resilient element normally urges and retains said power generator in a lower position that said friction rotor is frictionally biased against said driven portion of said rear wheel assembly to drive said rear wheel to rotate, so as to ensure a frictional power transmission between said friction rotor and said driven portion of said rear wheel assembly.

12. A scooter, as recited in claim 8, wherein said reinforcing engagement device comprises a resilient element having two ends connecting with said rear end portion of said supporting bar of said frame and an outer portion of said power generator respectively, wherein said resilient element normally urges and retains said power generator in a lower position that said friction rotor is frictionally biased against said driven portion of said rear wheel assembly to drive said rear wheel to rotate, so as to ensure a frictional power transmission between said friction rotor and said driven portion of said rear wheel assembly.

13. A scooter, as recited in claim 2, wherein said friction rotor is frictionally biased against a periphery surface of said rear wheel of said rear wheel assembly so as to drive said rear wheel to rotate.

14. A scooter, as recited in claim 3, wherein said friction rotor is frictionally biased against a periphery surface of said rear wheel of said rear wheel assembly so as to drive said rear wheel to rotate.

15. A scooter, as recited in claim 4, wherein said friction rotor is frictionally biased against a periphery surface of said rear wheel of said rear wheel assembly so as to drive said rear wheel to rotate.

16. A scooter, as recited in claim 10, wherein said friction rotor is frictionally biased against a periphery surface of said rear wheel of said rear wheel assembly so as to drive said rear wheel to rotate.

17. A scooter, as recited in claim 11, wherein said friction rotor is frictionally biased against a periphery surface of said rear wheel of said rear wheel assembly so as to drive said rear wheel to rotate.

18. A scooter, as recited in claim 12, wherein said friction rotor is frictionally biased against a periphery surface of said rear wheel of said rear wheel assembly so as to drive said rear wheel to rotate.

19. A scooter, as recited in claim 1, wherein said friction rotor is detachably attached to said output axle of said power generator by a connecting bolt coaxially connecting to said output axle through said friction rotor in such a manner that said friction rotor is adapted to selectively attach to and detach from said power generator in said driving position and in said idle position respectively.

20. A scooter, as recited in claim 1, wherein said power generator further comprises a handle bar affixed thereto for pivotally turning said power generator by pulling said handle bar upwardly to move said power generator from said driving position to said idle position.

21. A scooter, as recited in claim 2, wherein said power generator further comprises a handle bar affixed thereto for pivotally turning said power generator by pulling said handle bar upwardly to move said power generator from said driving position to said idle position.

22. A scooter, as recited in claim 3, wherein said power generator further comprises a handle bar affixed thereto for pivotally turning said power generator by pulling said handle bar upwardly to move said power generator from said driving position to said idle position.

23. A scooter, as recited in claim 4, wherein said power generator further comprises a handle bar affixed thereto for pivotally turning said power generator by pulling said handle bar upwardly to move said power generator from said driving position to said idle position.

24. A scooter, as recited in claim 16, wherein said power generator further comprises a handle bar affixed thereto for pivotally turning said power generator by pulling said handle bar upwardly to move said power generator from said driving position to said idle position.

25. A scooter, as recited in claim 17, wherein said power generator further comprises a handle bar affixed thereto for pivotally turning said power generator by pulling said handle bar upwardly to move said power generator from said driving position to said idle position.

26. A scooter, as recited in claim 18, wherein said power generator further comprises a handle bar affixed thereto for pivotally turning said power generator by pulling said handle bar upwardly to move said power generator from said driving position to said idle position.
